(19) United States
(12) Patent Application Publication
(10) Pub. No.: US 2020/0134658 A1
(43) Pub. Date: Apr. 30, 2020

(54) SYSTEM AND METHOD FOR A CASH BACK REWARD PROGRAM

(71) Applicant: Omid Sadeghpour, Los Angeles, CA (US)

(72) Inventor: Omid Sadeghpour, Los Angeles, CA (US)

(21) Appl. No.: 16/518,973

(22) Filed: Jul. 22, 2019

Related U.S. Application Data
(60) Provisional application No. 62/751,274, filed on Oct. 26, 2018.

(51) Int. Cl. G06Q 30/02; G06Q 30/06; G06Q 10/10; G06Q 40/00

(52) U.S. Cl. CPC G06Q 30/0234; G06Q 40/12; G06Q 10/1097; G06Q 30/0645

(57) ABSTRACT

The system and method for a cash back reward program utilizes and incentivizes the owner-renter relationship and encourage renters to become long-term renters. The cash back reward will vest when the renter satisfies a minimum required term. Payments are confirmed using a ledger of a renter's account expenditures, with a specialized algorithm to include edge-cases where a payment is made partially, late, or omitted.

### CROSS-REFERENCE TO RELATED APPLICATIONS

This application claims the benefit of U.S. Provisional Patent Application No 62/751,274, filed on Oct. 26, 2018, which is incorporated herein by reference.

### STATEMENT REGARDING FEDERALLY SPONSORED RESEARCH AND DEVELOPMENT

Not Applicable.

### FIELD OF THE INVENTION

This invention relates generally to cash back rewards, and more particularly, to a system and method for incentivizing long-term renters and assisting renters in renting property and goods through a cash back reward program.

### DISCUSSION OF RELATED ART

A cash back reward program can generally be described as a program to incentivize usage of a good or service by providing monetary compensation based upon that usage. The most common example of a cash back reward program is a credit card, where a percentage of the total amount spent through the credit card is returned to the cardholder. For example, a 3% credit card cash back reward program will return 3% of all purchases made on the credit card to the cardholder, either in direct monetary compensation or other form having a monetary value to the cardholder (points program, frequent flyer miles, etc.).

A rental agreement can generally be described as a contractual agreement between a property owner and a renter, where the property owner provides a temporary right to use their property to the renter. Rental agreements also include license agreements, leases, and any other agreements where a temporary interest in a good or property, both tangible or intangible, is granted from an owner to a 3^{rd} party. Typical rental agreements terms include duration, payment amount, payment frequency, deposit amount, and other terms and conditions negotiated between the parties.

A long-term renter is a renter who retains a property for twice as long as an average renter. A short-term renter is a renter who retains a property for less than the average renter. Long-term renters are favorable to short-term renters because they reduce vacancy rates and increase the occupancy rate of a property since long-term renters do not cause turnover. Given their long-term tenure, they are also more careful and require less attention, and as such, will have reduced repair and maintenance costs. Long-term renters can provide stability to a rental market and subsidize losses from short-term renters.

A property vacancy rate can generally be described as the percentage of time a property is unoccupied. Long-term renters result in low vacancy rates, while short-term renters result in high vacancy rates. Higher vacancy rates result in lower monthly cash-flows, lower overall selling prices, increased costs due to high renter turnover, and further require continuous advertising and marketing to find new renters, all of which lead to higher costs. Conversely, when the vacancy rate of a property drops, the cash-flows of said property increase, appreciating the value of the property.

Until now, there has been no scalable solution to identify and attract long-term renters to goods or property. While several forms of financial motivation exist, there are none that currently utilize an owner-renter relationship to encourage long-term renting. Furthermore, there are none that provide an incentive to both the owner and the renter through a long-term reward program. Lastly, there are none that will calculate rewards based on payment history and payment punctuality. Therefore, a need exists for a system and method for a cash back reward program that utilizes and incentivizes the owner-renter relationship and encourages renters to become long-term renters. The present invention satisfies these needs.

### SUMMARY OF THE INVENTION

The present invention will provide a system and method for a cash back reward program that utilizes and incentivizes the owner-renter relationship and encourages renters to become long-term renters. The present invention aims to create a beneficial scenario for both long-term renters and owners. Specifically, renters that utilize the reward program presented herein can receive 2-15% of their cumulative rental payments back when they satisfy a minimum required rental period. Although any property, good, or entity can be used in the present invention, landlords and real estate investors may further utilize the present invention to get better than average returns since their properties will have a near-zero percent vacancy rates, and overall, have lower repair costs—both of these factors ultimately increase the property's selling price and the cash flow of the owner.

The present invention will draw long-term renters to entities through a reward program. More specifically, the present invention will automatically add or track a percentage of the renter's monthly payment into a reward program which incentivize the renter to rent for at least a minimum required rental period. The minimum required rental period that the renter should rent the entity can be based on historic averages of a property or entity's vacancy and tenancy period, respectively. Given the unique characteristics of each geographic region, the value of the reward program and minimum required rental period can vary drastically. As such, owners in different geographic regions are given the liberty to define the terms of their cash back programs for their respective entities.

During the rental period, the owner can assign responsibilities to the renter through a workflow module. The present invention present will further present the renter with a calendar and list of tasks that need to be completed to ensure the entity is maintained and management costs remain at a minimum. Renters may further be incentivized by bonuses to their cash back reward by completing these tasks.

To avoid double taxation, and money holding regulatory requirements of many countries, the present invention will not hold or retain any monetary values in any accounts. Rather, payments may be made directly from the renter to the owner, and these payments are monitored and confirmed by parsing the renter's transaction history. When a cash back reward vests, the value is calculated and presented to the owner, who must then distribute this amount to the renter.

These and other objectives of the present invention will become obvious to those of ordinary skill in the art after reading the following detailed description of the preferred embodiments. It is to be understood that the foregoing general description and the following detailed description are exemplary, and are intended to provide further explanation of the invention as claimed.

### DESCRIPTION OF THE DRAWINGS

FIG. 1 is a diagram schematically illustrating a network wherein the server and client machines are connected;

FIG. 2 is a diagram schematically illustrating the modules of the system and method for a cashback reward program;

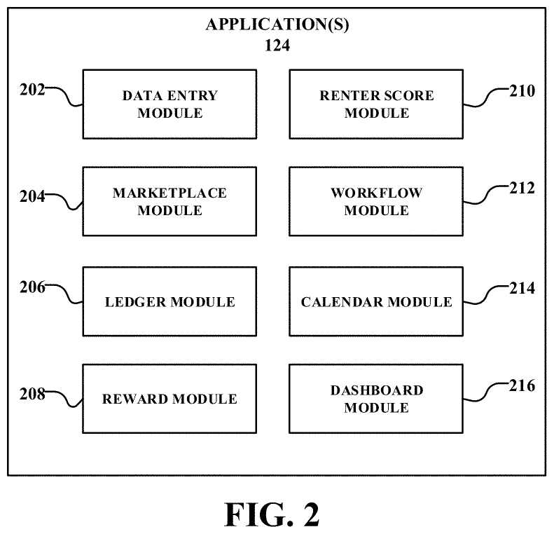

FIG. 3 is a diagram schematically illustrating the process flow of the system and method for a cashback reward program;

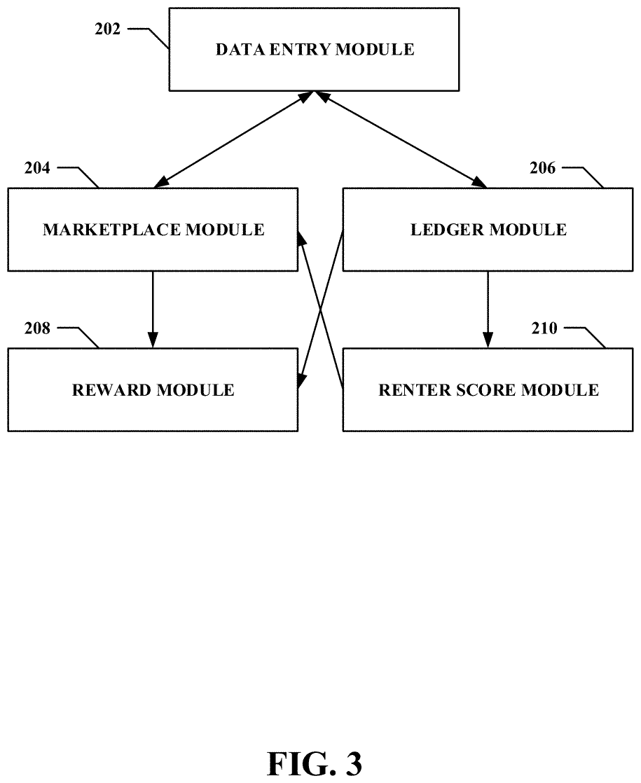

FIG. 4 is a diagram schematically illustrating the process flow of the system and method for a cashback reward program;

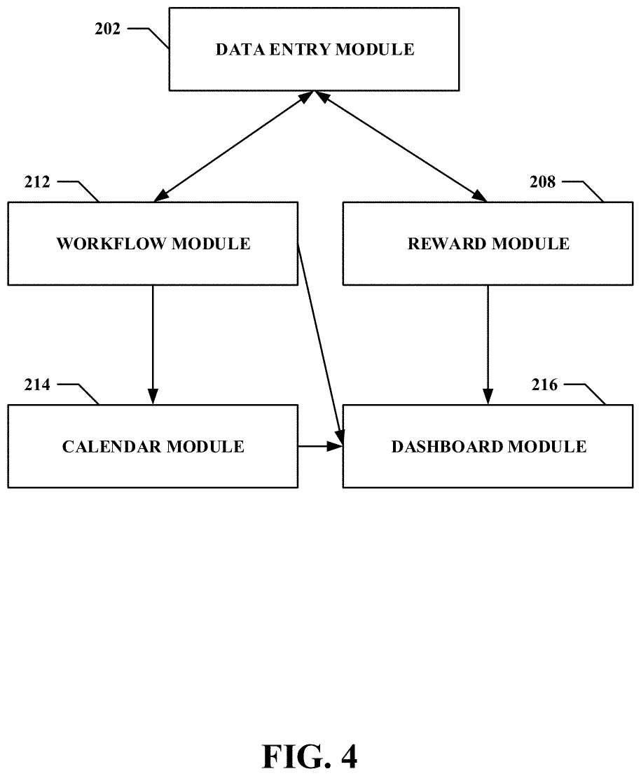

FIG. 5 is a diagram schematically illustrating a computer system suitable for implementing the aspects of the system and method for a cashback reward program;

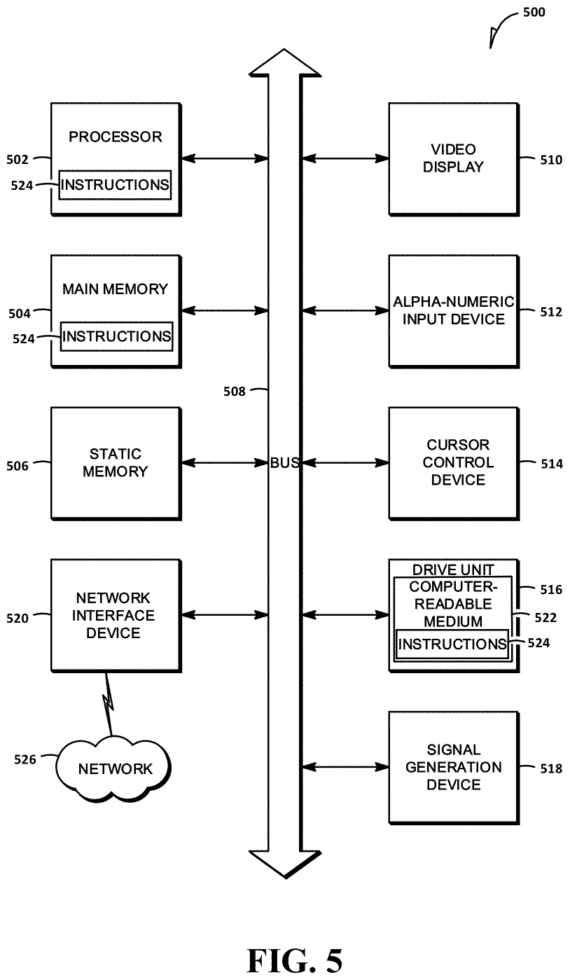

FIG. 6 is a diagram schematically illustrating the method of the present invention;

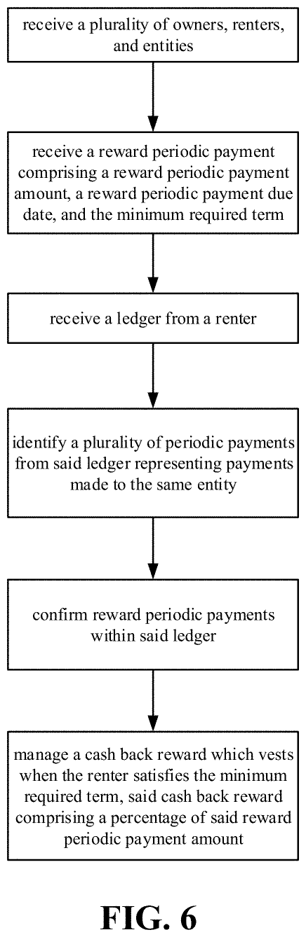

FIG. 7 is a diagram schematically illustrating the method of the present invention relating to the marketplace module;

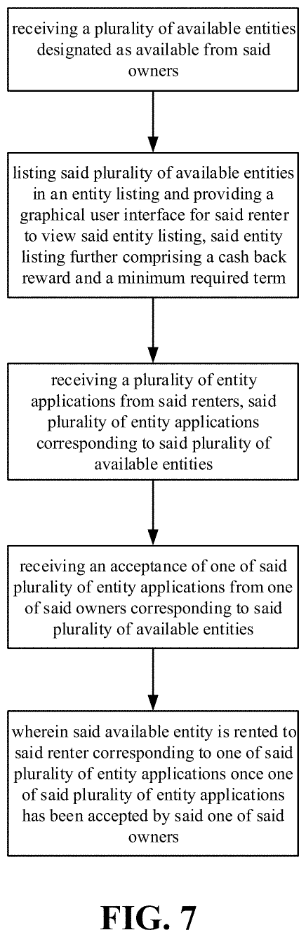

FIG. 8 is a diagram schematically illustrating the method of the present invention relating to the renter score module;

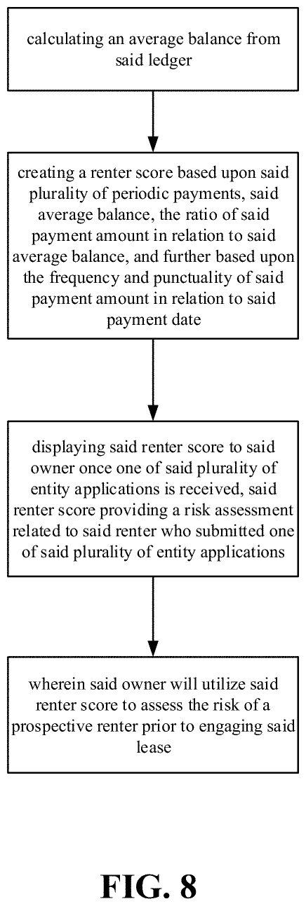

FIG. 9 is a diagram schematically illustrating the method of the present invention relating to the ledger module;

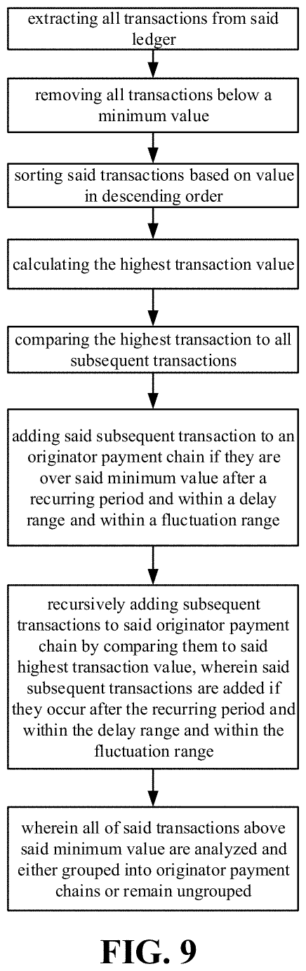

FIG. 10 is a diagram schematically illustrating the method of the present invention relating to the renter score module;

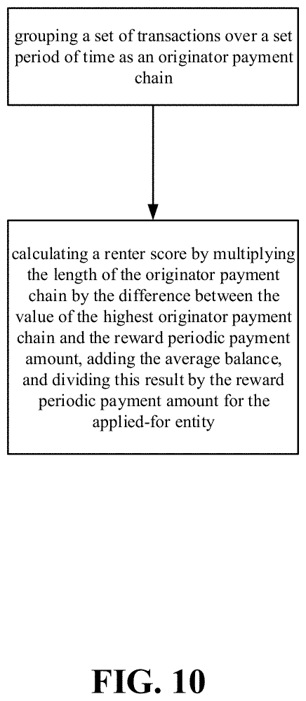

FIG. 11 is a diagram schematically illustrating the method of the present invention relating to the ledger module;

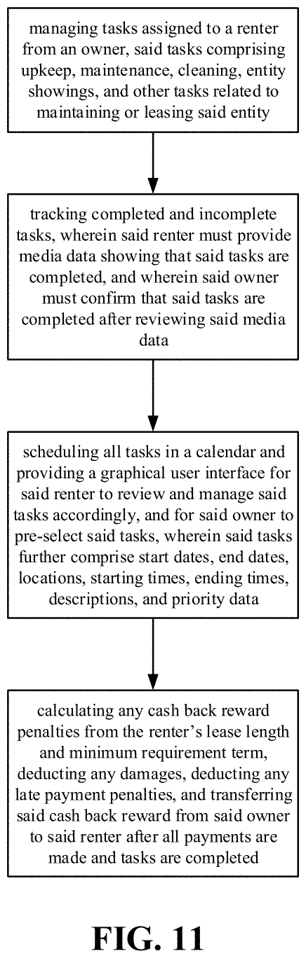

FIG. 12 is a diagram schematically illustrating the method of the present invention relating to the reward module;

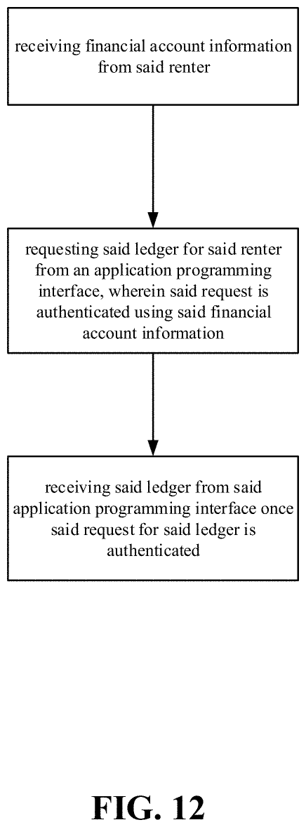

FIG. 13 is a diagram schematically illustrating the method of the present invention relating to the dashboard module;

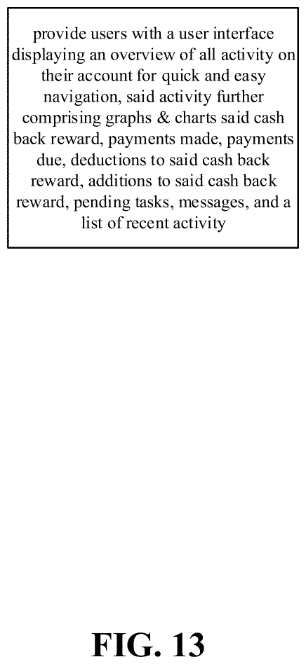

FIG. 14 is a diagram schematically illustrating the method of the present invention relating to the reward module;

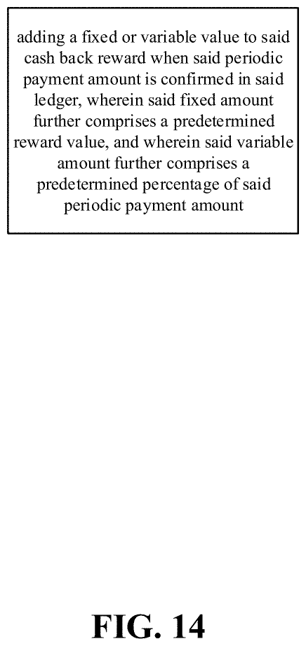

FIG. 15 is a graph illustrating a plurality of periodic payments;

FIG. 16 is an image illustrating the marketplace module;

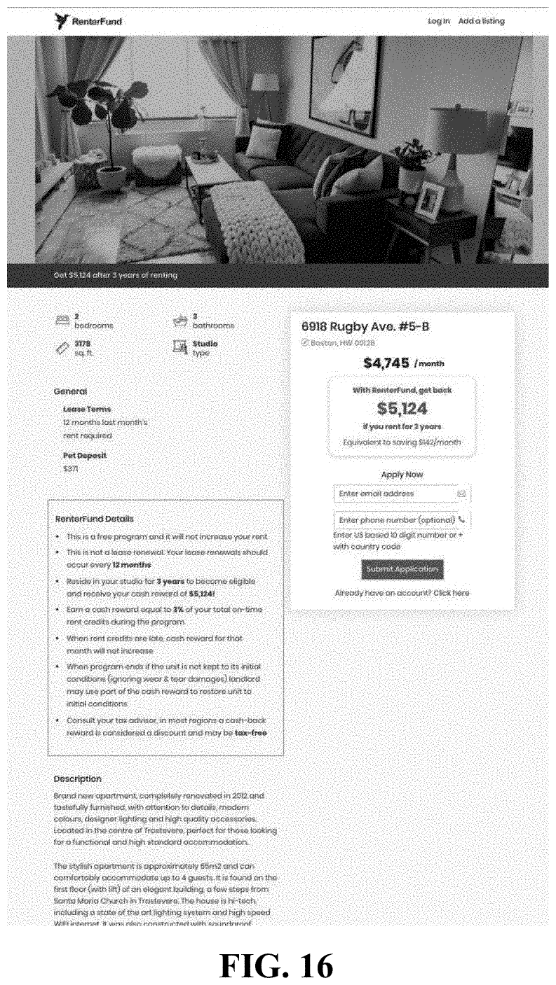

FIG. 17 is an image illustrating the marketplace module where the cash back reward terms are input; and

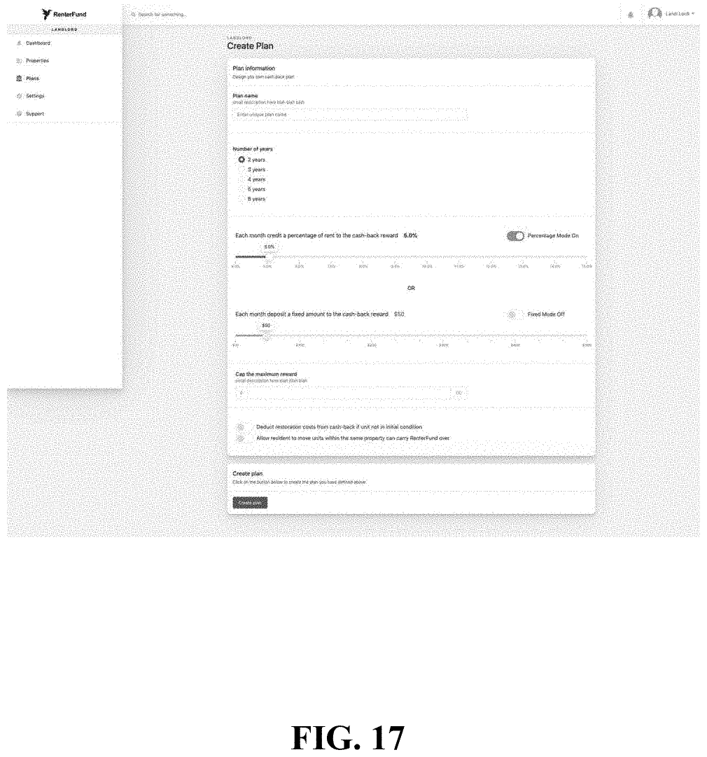

FIG. 18 is an image illustrating the workflow module where the owner can create tasks for the renter.

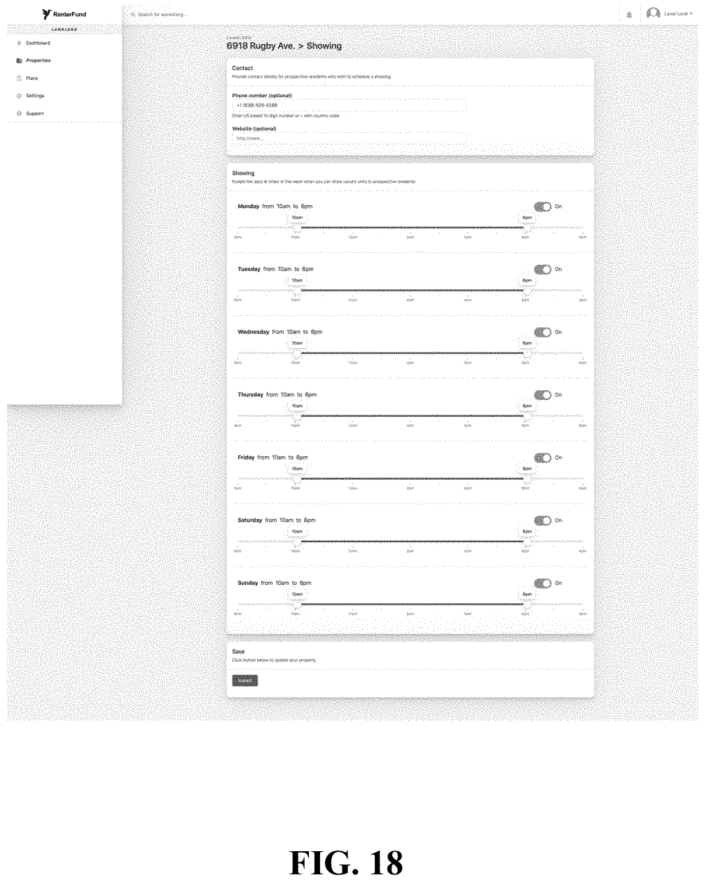

### DETAILED DESCRIPTION OF THE PREFERRED EMBODIMENT

Illustrative embodiments of the invention are described below. The following explanation provides specific details for a thorough understanding of and enabling description for these embodiments. One skilled in the art will understand that the invention may be practiced without such details. In other instances, well-known structures and functions have not been shown or described in detail to avoid unnecessarily obscuring the description of the embodiments.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list.

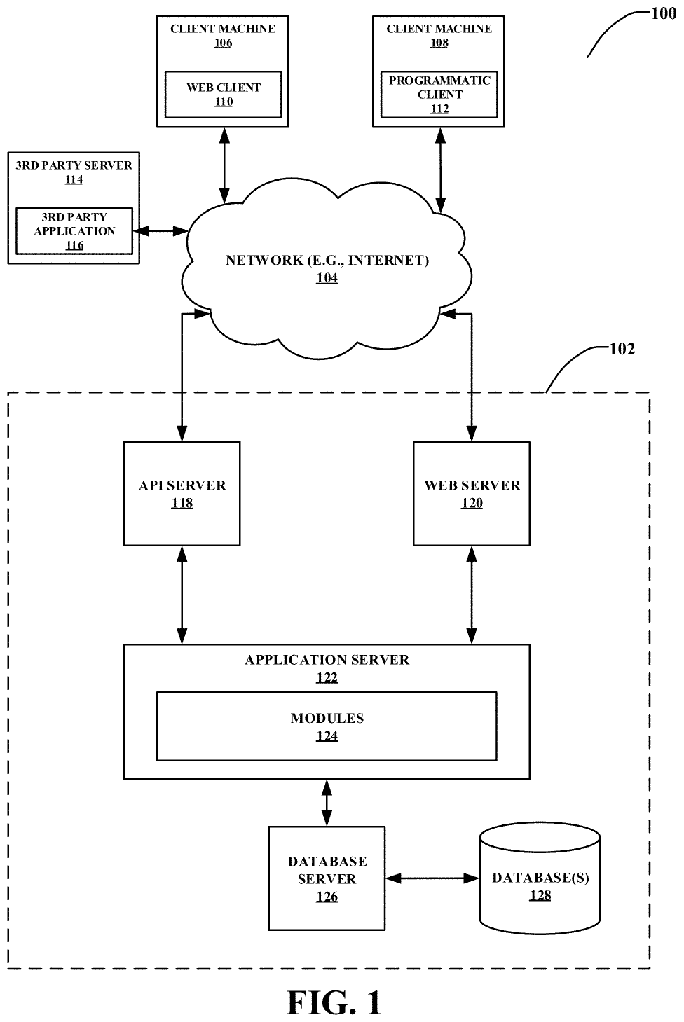

FIG. 1 depicts a block diagram of a computer system 100 suitable for implementing aspects of the present invention. As shown in FIG. 1, a computer system 100 includes the present invention 102, which interconnects major subsystems such as an API server 118, web server 120, application server 122, and database server 126 having a non-transitory storage medium 522. The application server 122 consists of several modules 124, and a database 128 exists on the database server 126. The present invention 102 connects to client machines 106 and 108, as well as 3rd party servers 114, through a network 104. Web clients 110 and programmatic clients 112 exist on the client machines 106 and 108, respectively, and 3rd party applications 116 that exist on the third-party server 114.

The present invention comprises a processor-implemented system and method for a cash back reward, the system and method comprising a data entry module 202, a marketplace module 204, a ledger module 206, a reward module 208, a renter score module 210, a workflow module 212, a calendar module 214, and a dashboard module 216. These modules work in conjunction to provide an intuitive and functional portal from which users may manage entity rentals using an innovative cash-back reward program that facilitates and incentivizes the owner-renter relationship and encourages renters to become long-term renters or owners. Users can manage their accounts, perform tasks, communicate with owners, review documents, and otherwise perform any tasks or actions related to their account or entity using a mobile device or website.

The data entry module 202 is configured to receive and store all user and entity data. More specifically, the data entry module 202 is configured to create user accounts, manage user passwords, parse user and entity data, receive financial information, receive ledgers, and otherwise receive and store all data related to the present invention. The data entry module 202 further comprises a database for storing all user and entity data. The database is stored on a non-transitory computer-readable storage medium in electrical communication with at least one microprocessor.

In the preferred embodiment, users comprise owners and renters, while entities comprise goods or property. An owner comprises a legal titleholder of an entity who seeks to assign a partial interest in said entity to a renter, who agrees to receive the partial interest in said entity in return for monetary compensation. Typically, a rental agreement is negotiated between the parties, which comprises monetary compensation in the form of a periodic payment (weekly, bi-weekly, monthly, bi-monthly, etc.), although any periodic payment method can be used. Each jurisdiction will have laws governing the rights and duties of owners and renters with respect to the entity being transferred, and enforcement of those laws are outside the purview of the present invention. Specifically, the present invention seeks to facilitate the relationship between the owner and renter, while incentivizing the relationship using a reward structure. As such, the present invention will not negotiate terms of the rental agreement or mediate disputes between parties and will not review and enforce terms that were negotiated between parties.

The marketplace module 204 is configured to facilitate the transfer of a partial interest in an entity from an owner to a renter in return for financial compensation. Each transfer comprises an entity, an owner, a renter, and a reward agreement defining the terms of the cash back reward. The reward agreement comprises a reward periodic payment amount, a reward periodic payment due date, and a minimum required term which defines the minimum period of time a renter must make payments to an owner before their reward vests. The owners and renters are free to negotiate how they please so long as they define the entity in question, the terms of the transfer of a partial interest in the entity, the terms of the reward, and the financial compensation for the entity.

The marketplace module 204 will receive a plurality of available entities from owners which are designated as available. The marketplace module 204 will list the plurality of available entities in an entity listing and provide a graphical user interface for renters to view said entity listing. Each entity listing provides information relating to the entity and the listing terms that the owner seeks in renting the entity. Listing terms comprise payment amount, rental period, rights and limitations of the transfer, cash back reward terms, and the minimum required term for the cash back reward to vest.

The marketplace module 204 will receive a plurality of rental applications from renters after viewing the entity listing. Each rental application corresponds to a single entity in the entity listing, and provides the owner with information about the renter and why they should be accepted. Here, the owner and prospective renter can negotiate the fine details of the rental and reward agreements. After reviewing the rental applications and negotiating terms, the owner of the entity in question will accept a rental application and upload a rental agreement and reward agreement defining the terms of the transfer and cash back reward, which are stored in the data entry module 202. Afterwards, the entity will transfer partially from the owner to the renter subject to the terms of the rental agreement and it will be removed from the entity listing of the marketplace module 204.

The ledger module 206 is configured to receive and process a ledger. A ledger is defined as a list of transactions over a period of time, where the list of transactions may further comprise a plurality of periodic payments. The ledger module 206 will either receive the ledger from a renter, application programming interface (API), or from a 3^{rd} party. More specifically, the ledger may be manually uploaded by a renter, or may be automatically received through an API. The API may comprise an internal API from a local database, or may comprise an external API from a 3^{rd} party, such as a financial institution (bank, credit union, online payment center, etc.), collections agency, or other 3^{rd} party.

In the preferred embodiment, the ledger module 206 will automate the receipt of the ledger by first receiving financial institution API and account data from the renter, along with any credentials necessary to authorize the release of the renter's financial information. Next, the ledger module 206 will send a request the renter's ledger from the financial institution's API using said data along with any credentials necessary to process the API request. Lastly, the ledger module 206 will automatically receive the ledger from the financial institution's API once the API request is authenticated and processed, wherein the ledger is then stored in the data entry module 202. In an alternative embodiment, the ledger module 206 will periodically update the ledger stored in the data entry module 202 by automatically sending an API request to the API and updating any new transactions.

Once a ledger is received, the ledger module 206 will begin processing the ledger, first calculating the average balance, lowest balance, and highest balance within the ledger. Next, the ledger module 206 will identify the highest monthly recurring payment from the plurality of periodic payments from the ledger, where the plurality of periodic payments have a payment amount, transaction name, transaction description, and payment date. Here, the highest monthly recurring payments represent a high-value purchase or lease by the renter. For most renters, their highest monthly recurring payment is their rental payment. As such, by identifying the highest monthly recurring payment from a ledger of payments, the present invention can avoid complex information gathering and computational algorithms to achieve the same outcome by identifying the highest monthly recurring payment from all the transactions of a renter. The ledger module 206 is further configured to confirm within the ledger that the reward periodic payment amount from the renter to said owner has been completed and to determine if any periodic payment amounts were paid late.

When calculating the highest monthly recurring payment, the ledger module 206 must first parse all transactions in the ledger that are over a minimum value and determine whether this subset of transactions can be labeled as a plurality of periodic payments representing a high-value purchase or lease (house, car, etc.). More specifically, the ledger module 206 will first extract all transactions from the ledger above a minimum value, discard the remaining transactions, and sort them in descending order. The minimum value comprises a value for which it is understood that any transaction below this value is unlikely to be a highest monthly recurring payment given the entity in question. In the preferred embodiment, the minimum value is defined as the lowest reasonable periodic payment amount for the same or similar entity in a specific geographic region. The minimum value may further be divided by a factor of 2 or 3 to include compensate for periodic payments which are split into multiple payments, or to compensate for payments that were otherwise split or shared.

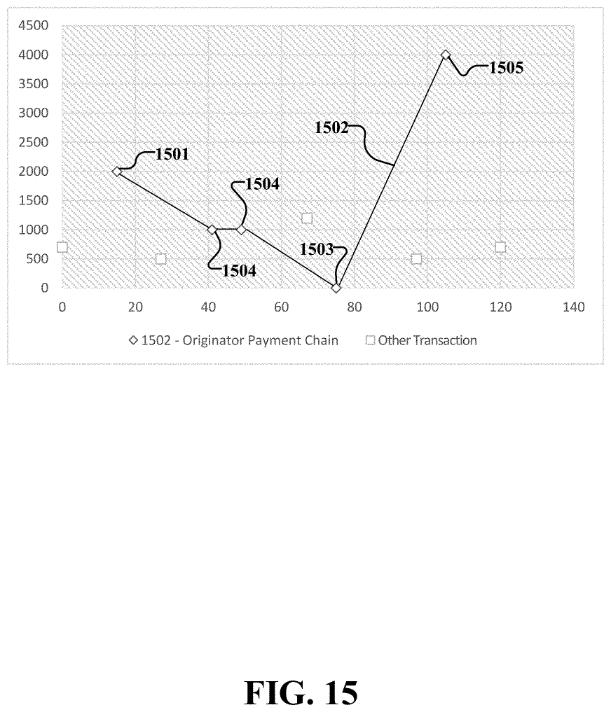

The ledger module 206 will start with the highest remaining values, then recursively parse any remaining values to determine if they are related to the same entity, specifically as periodic payments made toward said entity. The goal here is to identify and group any periodic payments which are made for the same entity of high value (house, car, student loan, etc.), while also evaluating edge-case transactions that may be part of these periodic payments (late payments, partial payments, missed payments, etc.). It is helpful to think of the values as placed on an X-Y graph, as seen in FIG. 15, with a recurring period on the X-axis (in days) and the payment amount on the Y-axis (in dollars). The recurring period may represent any time period, although a monthly recurring period is the most prevalent.

The first transaction is designated as the originator transaction 1501. The ledger module 206 will analyze all remaining transactions to determine whether they can be grouped with the originator transaction 1501 to form an originator payment chain 1502.

Furthermore, each originator transaction 1501 will have a delay range, comprising a value that is both added to and subtracted from the payment date to define the upper and lower bounds of the delay range. Only payments made within this delay range will be analyzed for addition to the originator payment chain 1502. For example, if the originator transaction 1501 was recorded on January 15^{th}, the recurring period is monthly, and the delay range is 5 days, only payments made between February 10^{th} and 20^{th} will be analyzed. This analysis will help determine whether subsequent payments that were made on time, early, late, or otherwise include a variable fee such as a late fee or non-periodic change in price should be included in the originator payment chain 1502.

Remaining transactions will be analyzed to determine if they are linked transactions, unlinked transactions 1503, multi-linked transactions 1504, and multiplier transactions 1505, each representing a normal or edge case payment that is related to the same entity. A linked transaction is a single-transaction payment whose value is within the fluctuation range and delay range of the originator transaction, where the fluctuation range is a percentage of the originator transaction 1501. The fluctuation range will help to include edge-case payments where the payment amount changes, but the payment still represents the same entity (fees, repairs, taxes, etc.) Continuing the example above, if the fluctuation range is 5%, any payments made between February 10th and 20th that are within 5% of the originator transaction's value will be added to the originator payment chain 1502 as a linked transaction.

An unlinked transaction 1503 is the absence of a transaction within the fluctuation range and delay range of the originator transaction 1501. Unlinked transactions 1503 represent missed payments or are used to determine edge-case situations where periodic payments are missed or paid partially, in advance, or late. If an unlinked transaction 1503 is found, the ledger module 206 will begin analysis for a multi-linked transaction 1504 or multiplier transaction 1505 to replace it with, if found. Continuing the example above, if no payments are made between February 10th and 20th that are within 5% of the originator's value, an unlinked transaction 1503 will be added to the originator payment chain 1502 and the ledger module 206 will continue to search for multi-linked transactions 1504 or multiplier transactions 1505.

A multi-linked transaction 1504 is a plurality of payments that, when added together, are within the fluctuation range and delay range of the originator transaction 1501. A multi-linked transaction 1504 is only used when an unlinked transaction 1503 is found. A multi-linked transaction 1504 is an edge-case analysis to determine if a plurality of partial payments were made that, when considered together, represent a single periodic payment. Continuing the example above, if no payments are made between February 10th and 20th that are within 5% of the originator's value, but several payments are made within February 10^{th} and 20^{th} that, when added together, are within 5% of the originator's value, the unlinked transaction 1503 will be replaced by a multi-linked transaction 1504 in the originator payment chain 1502.

A multiplier transaction 1505 is a payment made within the delay range whose value is a multiple of the value of the originator transaction 1501. A multiplier transaction 1505 is only used when an unlinked transaction 1503 is found. A multiplier transaction 1505 is an edge-case analysis to determine if a single payment represents a plurality of periodic payments. Continuing the example above, if no payments are made between February 10th and 20th that are within 5% of the originator's value, but a single payment is made on March 15^{th} that is double the originator payment 1501, the unlinked transaction 1503 will be replaced by a multiplier transaction 1505 in the originator payment chain 1502. Multiplier transactions 1505 may be made before or after unlinked transactions 1503 are found, and a single multiplier transaction 1505 may represent several unlinked transactions 1503. Furthermore, multiplier transactions 1505 may comprise a fluctuation range where the multiplier transaction 1505 may be a multiple of the originator transaction 1501 within a percentage range.

All remaining payments are analyzed recursively until all transactions are either grouped into originator payment chains 1502 or remain ungrouped. As discussed above, each originator payment chain 1502 represents a plurality of periodic payments made to the same entity. As such, this analysis can be used to confirm payments within the ledger module 206. More specifically, the above-identified reward periodic payments are confirmed as paid by identifying an originator payment chain 1502 with matching reward periodic payment amounts and reward periodic payment dates to the reward periodic payments. Furthermore, the highest monthly recurring payment is the originator payment chain 1502 having the highest value. In an alternative embodiment, the ledger module 206 may be given a ledger having a date range, wherein only transactions within this date range may be used to formulate originator payment chains 1502.

The reward module 208 is configured to manage a cash back reward which incentivizes the owner-renter relationship and encourages renters to be long term renters. The cash back reward is a monetary value paid from the owner to the renter as defined in the reward agreement. In the preferred embodiment, the cash back reward comprises a percent of the reward periodic payment amount paid on time from the renter to the owner during the term of the reward agreement. In an alternative embodiment, a fixed or variable value is credited to the cash back reward when the on-time reward periodic payment amount is confirmed in the ledger. For example, the fixed amount is a predetermined reward value (e.g. $50/month), and the variable amount is a predetermined percentage of the periodic payment amount (e.g. 2% of on-time reward periodic payments). Owners in different geographic regions are granted the liberty to define the terms of their cash back programs for their respective entities and geographies.

In the preferred embodiment, the cash back reward vests if the rental period of the reward agreement is equal to or longer than the minimum required term for the cash back reward in the reward agreement. The minimum required term is a critical element of the reward agreement, as the purpose of the present invention is to incentivize renters to become long-term renters, and as such, the minimum required term will always be negotiated in advance. Furthermore, in the preferred embodiment, the payment punctuality is also critically important, as late payments will not be considered when calculating the cash back reward. As such, the reward module 208 will receive confirmation from the ledger module 206 that all reward periodic payment amounts have been paid and if any have been paid late. The reward module 208 will then calculate the cash back reward by crediting a percentage of all reward periodic payment amounts paid on time. The ledger module 206 will automatically calculate if any payments are late, but owners are also able to flag payments as late manually. More specifically, all rental payments can be flagged as late by the owner until the minimum required term of the reward agreement is satisfied.

In an alternative embodiment, if the cash back reward has not vested, the reward module 208 will calculate any cash back reward penalties from the rental period and minimum requirement term and deduct them from the cash back reward. The cash back reward penalties are negotiated and agreed to by both parties prior to engaging in the reward agreement. In a further alternative embodiment, the cash back reward may be reduced by property damages, late payment penalties, or other damages. In yet a further alternative embodiment, the cash back reward will be paid until all payments are made and tasks are completed. In still a further alternative embodiment, the renter may transfer the cash back reward between entities prior to satisfying the minimum required term of the reward agreement with owner approval. Here, the minimum required term may or may not be reset after the transfer is completed. In still a further alternative embodiment, the reward may be the right to rent the entity for an extended period of time without payment, where the period of time is proportional in value to the cash back reward.

The renter score module 210 is configured to create a renter score based upon the ledger of a renter. The renter score may be presented to an owner for each rental application that they receive, where the owner will utilize the renter score to assess the risk of a prospective renter prior to engaging the rental and reward agreements. The renter score is generated for each applicant renter from a plurality of periodic payments, highest monthly recurring payment, the average balance, the ratio of said payment amount in relation to the average balance, and further based upon the frequency and punctuality of the payment amount in relation to the payment date. By analyzing the payment history of a renter, the present invention seeks to identify the payment behavior of the user and to generate a renter score that accurately describes the risk of doing business with said renter. Unlike other credit report scores, the renter score is a score that directly compares the renter to the applied-for entity. For example, a renter score of A+ for a renter and entity combination may be different when the same renter applies to an entity having a different price point in the same location, or an entity having the same price point in a different location where said renter compares differently to the general pool of applicants.

When computing the renter score, the renter score module 210 will receive the highest monthly recurring payment from the ledger module 206. Once the highest monthly recurring payment is received, the renter score module 210 will generate a renter score based upon the duration and value of the highest monthly recurring payment, the periodic payment amount for the applied-for entity, the average balance, the geographic region of the entity, and any late payments. In an exemplary embodiment, the duration (D) of the applicant's highest monthly recurring payment chain will be multiplied by the difference between the applicant's highest monthly recurring payment (HMRP) and the periodic payment amount for the applied-for entity (EPPA). This value represents the net positive or negative that the renter will have in savings (or debt) after renting the applied-for entity for the same duration. The result of this exemplary renter score calculation is then added to the applicant's average balance (AB), after which, the entire result is divided by the periodic payment amount for the applied-for entity. A formula representing this exemplary embodiment is presented below:

(D*(HMRP−EPPA)+AB)/EPPA

The result of this exemplary renter score calculation represents the total value the renter will have in their account after renting the applied-for entity for the same duration as they rented their previous unit. For example, if the duration is over one year, and the result of the previous calculation is over a regional factor (ex. six), then the renter is given a favorable score. The spirit of the renter score is to generate a unique score for the combined applicant and entity being applied for using the applicant's highest monthly recurring payment history which can be derived from a ledger of transactions. Different geographies will require unique methods of assessing the positive qualities of said applicant, where some methods will also require comparing the applicant relative to the applicant pool of the region.

The renter score can be adapted to fit into any number of scoring systems. In an alternative exemplary embodiment, the renter score may be based upon an academic grading system with an associated numerical value between 0-100, where scores below 60 receive a failing letter grade (F) and scores between 60-100 receive a passing letter grade (A-D). In this exemplary embodiment, the score will start at 80 and will be added to the exemplary renter score calculation presented above and may further be reduced by any late payments. In all embodiments, the score will depend on the geographic region and will reflect favorably to positive transactions (on-time payments, long-term transaction chains, high average balance, etc.) and will reflect unfavorably to negative transactions (missed payments, short-term transaction chains, low average balance, etc.).

The workflow module 212 is configured to manage tasks assigned from an owner to a renter as defined in the reward agreement. These tasks include entity upkeep, maintenance, cleaning, and other entity-related tasks. The renter will be reminded by SMS, email, post, or telephone that they must complete these tasks to comply with the reward agreement. The workflow module 212 will display all tasks in list form, where a task is moved between lists once it has commenced or has completed. The workflow module 212 comprises three lists; a “To-do” list, an “In Progress” list, and a “Completed” list. Tasks that are upcoming fall under the “To-do” list, while tasks that have commenced fall under the “In Progress” list. Once a task is completed, it is placed in the “Completed” list. After a fixed time period, these tasks are removed from the “Completed” list.

In the preferred embodiment, the renter may provide media data (photos, video, etc.) showing the tasks are completed as a means to enforce compliance, although this may be negotiated between parties in the reward agreement. In this embodiment, the owner must confirm that the tasks are completed after reviewing the media data. In an alternative embodiment, the owner does not confirm that tasks are completed and instead trusts the renter. Here, if the renter has marked a task as completed when it hasn't been completed, the renter will be liable for any and all damages resulting from the incompletion of the task.

The calendar module 214 operates in tandem with the workflow module 212 and is configured to schedule all tasks assigned by the workflow module 212 and provide a graphical interface for the renter to review and manage the tasks accordingly, and for the owner to pre-set such tasks. In the preferred embodiment, the calendar module 214 will provide a graphical calendar displaying all tasks that enables renters to manage their workflow. Tasks comprise repeating tasks (clean screen weekly, charge batteries monthly, change filters bi-annually, etc.) and non-repeating tasks (fix broken panel, repair damaged door, etc.). Tasks further comprise dates, places, starting times, ending times, and descriptions. Tasks may further be labeled by color manually or automatically to help the renter distinguish between critical tasks and non-critical tasks. The calendar module 214 can also integrate with third-party calendar services.

The dashboard module 216 is configured to provide owners and renters with an overview of all activity on their account for quick and easy navigation. In other words, the dashboard module 216 is configured to get users up to speed without having to navigate through other menus or otherwise spend time excess understanding their account. The dashboard module 216 is be configured to display any information that users find relevant, including graphs and charts for the cash back reward, remaining term length, pending tasks, messages from the owner, and a list of recent activity.

When in use, the present invention must first be populated with entities from owners who seek to incentivize existing or new renters into becoming long term renters. Owners will create user accounts and upload entity information, which is then calculated and stored by the data entry module 202. Owners will submit their entities on the marketplace module 204, including a thorough description of the entity and its condition, the reward periodic payment amount, the reward periodic payment due date, the entity total value, the minimum required term, the cash back reward or reward percentage, and any additional terms and conditions. Once their entities are listed, they will be available for all prospective renters to see.

Next, renters will create user accounts and upload user data, which is then calculated and stored by the data entry module 202. Renters may also submit a ledger of their most recent transactions, which will be parsed by the ledger module 206. Renters will then view entities listed by owners and submit a rental application. Once a rental application is received from a renter, the renter score module 210 will generate a renter score for the prospective renter based upon the geographic region, value of the entity, average balance, and payment history with specific regard to large recurring payments (house, car, loan, etc.). This renter score may be displayed for the owner to quickly and easily determine whether the prospective renter is a high-risk renter or low-risk renter. Once the terms of the rental and reward agreements are signed, the agreements will be submitted by all parties and stored in the data entry module 202 along with any addendums or other legal information.

Periodically, the renter may be given tasks to complete. These tasks may include entity upkeep, maintenance, and other entity-related tasks. The renter will be reminded by SMS, email, post, or telephone through the workflow module 212 that they must complete these tasks to comply with the reward agreements. All tasks will also be presented for the easy viewing in the calendar module 214. In the preferred embodiment, the renter must provide media data (photos, video, etc.) showing the tasks are completed as a means to enforce compliance, although this may be negotiated between parties prior to engaging into the reward agreement.

Each periodic payment period, the renter is required to pay the reward periodic payment amount. The ledger module 206 will automatically request the account transaction history of the renter and confirm that the payments have been made. The reward module 208 will monitor all payments and add or deduct any bonuses or penalties that result from positive or negative behavior, respectively. For example, late or missed payments may lower the cash back reward amount, while on-time payments and payments in advance may increase the cash back reward amount.

When a renter has satisfied the minimum required term, their cash back reward will be calculated and dispersed. First, the rewards module 208 will determine the total amount of the cash back reward. Next, the rewards module 208 will determine whether the minimum required term has been met. Next any bonuses will be added and penalties will be deducted from the cash back reward. Lastly, the cash back reward will be dispersed from the owner to the renter.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Changes can be made to the invention in light of the above “Detailed Description.” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

What is claimed is:

1. A processor-implemented method for a cash back reward, the method comprising:
receiving a plurality of users and entities, wherein said plurality of users further comprise owners and renters, and wherein said plurality of entities further comprise goods or property;
receiving a reward periodic payment comprising a reward periodic payment amount, a reward periodic payment due date, and a minimum required term, said minimum required term further comprising the minimum period of time said renter must make payments to said owner;
receiving a ledger from said renter, said ledger further comprising a list of said renter's financial expenditures;
identifying a plurality of periodic payments from said ledger, said plurality of periodic payments representing payments related to the same entity,;
managing a cash back reward, wherein said cash back reward vests when said renter satisfies the minimum required term; and
storing all data on a non-transitory computer-readable storage medium in electrical communication with at least one microprocessor;
wherein said cash back reward incentivizes the owner-renter relationship and encourages renters to become long-term renters.

2. The processor-implemented method of claim 1, further comprising:
receiving a plurality of available entities designated as available from said owners;
listing said plurality of available entities in an entity listing and providing a graphical user interface for said renter to view said entity listing, said entity listing further comprising a cash back reward and a minimum required term;
receiving a plurality of rental applications from said renters, said plurality of rental applications corresponding to said plurality of available entities; and
receiving an acceptance of one of said plurality of reward applications from one of said owners corresponding to said plurality of available entities;
wherein said available entity is rented to said renter corresponding to one of said plurality of rental applications once one of said plurality of rental applications has been accepted by said one of said owners.

3. The processor-implemented method of claim 2, further comprising:
calculating an average balance from said ledger;
creating a renter score based upon said plurality of periodic payments, said average balance, the ratio of said payment amount in relation to said average balance, and further based upon the frequency and punctuality of said payment amount in relation to said payment date; and
displaying said renter score to said owner once one of said plurality of rental applications is received, said renter score providing a risk assessment related to said renter who submitted one of said plurality of rental applications;
wherein said owner will utilize said renter score to assess the risk of a prospective renter.

4. The processor-implemented method of claim 1, wherein said identifying a plurality of periodic payments further comprises:
extracting all transactions from said ledger;
removing all transactions below a minimum value, said minimum value comprising the average periodic payment amount for the same or similar entity in the same geographic region;
calculating the highest transaction value;
comparing the highest transaction value to a subsequent transaction;
adding said subsequent transaction to an originator payment chain if they are over said minimum value after a recurring period and within a delay range and within a fluctuation range, said recurring period comprising a defined time period for periodic payments, said delay range comprising a range before or after said recurring period, said fluctuation range comprising a percentage of said highest transaction value;
recursively adding subsequent transactions to said originator payment chain by comparing them to said highest transaction value, wherein said subsequent transactions are added if they occur after the recurring period and within the delay range and within the fluctuation range; and
wherein all of said transactions above said minimum value are analyzed and either grouped into originator payment chains or remain ungrouped.

5. The processor-implemented method of claim 4, further comprising calculating a renter score by multiplying the length of the originator payment chain by the difference between the value of the highest originator payment chain and the reward periodic payment amount, adding the average balance, and dividing this result by the reward periodic payment amount for the applied-for entity.

6. The processor-implemented method of claim 4, wherein said reward periodic payment from said renter to said owner is confirmed within said ledger.

7. The processor-implemented method of claim 1, further comprising:
receiving financial account information from said renter;
requesting said ledger for said renter from an application programming interface, wherein said request is authenticated using said financial account information;
receiving said ledger from said application programming interface once said request for said ledger is authenticated.

8. The processor-implemented method of claim 1, wherein said cash back reward further comprises the sum of all on-time reward periodic payment amounts multiplied by a percentage, said reward periodic payment amount confirmed as on time if said reward periodic payment amount is made on or before said reward periodic payment due date, said ledger module confirming said on-time reward periodic payments through said ledger.

9. The processor-implemented method of claim 1, wherein said cash back reward further comprises the sum of the number of all on-time reward periodic payment amounts multiplied by a fixed value, said reward periodic payment amount confirmed as on time if said reward periodic payment amount is made on or before said reward periodic payment due date, said ledger module confirming said on-time reward periodic payments through said ledger.

10. The processor-implemented method of claim 1, further comprising managing tasks assigned to a renter from an owner, said tasks comprising upkeep, maintenance, cleaning, entity showings, and other tasks related to maintaining or renting said entity.

11. The processor-implemented method of claim 10, further comprising tracking completed and incomplete tasks, wherein said renter must provide media data showing that said tasks are completed, and wherein said owner must confirm that said tasks are completed after reviewing said media data.

12. The processor-implemented method of claim 10, further comprising scheduling all tasks in a calendar and providing a graphical user interface for said renter to review and manage said tasks accordingly, and for said owner to pre-select said tasks, wherein said tasks further comprise start dates, end dates, locations, starting times, ending times, descriptions, and priority data.

13. The processor-implemented method of claim 10, further comprising calculating any cash back reward penalties from the rental period and minimum requirement term, deducting any damages, deducting any late payment penalties, and transferring said cash back reward from said owner to said renter after all payments are made and tasks are completed.

14. The processor-implemented method of claim 1, further comprising provide users with a user interface displaying an overview of all activity on their account for quick and easy navigation, said activity further comprising graphs & charts said cash back reward, payments made, payments due, deductions to said cash back reward, additions to said cash back reward, pending tasks, messages, and a list of recent activity.

15. The processor-implemented method of claim 1, further comprising adding a fixed or variable value to said cash back reward when said periodic payment amount is confirmed in said ledger, wherein said fixed amount further comprises a predetermined reward value, and wherein said variable amount further comprises a predetermined percentage of said periodic payment amount.

16. A system for a cash back reward, the system comprising:
a data entry module configured to receive a plurality of users and entities, wherein said plurality of users further comprise owners and renters, and wherein said plurality of entities further comprise goods or property;
a marketplace module configured to receive a reward periodic payment comprising a reward periodic payment amount, a reward periodic payment due date, and a minimum required term, said minimum required term further comprising the minimum period of time said renter must make payments to said owner;
a ledger module configured to receive a ledger from said renter, said ledger further comprising a list of said renter's financial expenditures, wherein said ledger module will identify a plurality of periodic payments from said ledger, said plurality of periodic payments representing payments related to the same entity, wherein said reward periodic payment from said renter to said owner is confirmed within said ledger;
a cash back reward module configured to manage a cash back reward, wherein said cash back reward vests when said renter satisfies the minimum required term; and
wherein all data is stored on a non-transitory computer-readable storage medium in electrical communication with at least one microprocessor, and wherein said cash back reward incentivizes the owner-renter relationship and encourages renters to become long-term renters.

17. The system of claim 16, further comprising:
receiving a plurality of available entities designated as available from said owners;
listing said plurality of available entities in an entity listing and providing a graphical user interface for said renter to view said entity listing, said entity listing further comprising a cash back reward and a minimum required term;
receiving a plurality of rental applications from said renters, said plurality of rental applications corresponding to said plurality of available entities; and
receiving an acceptance of one of said plurality of reward applications from one of said owners corresponding to said plurality of available entities;
wherein said available entity is rented to said renter corresponding to one of said plurality of rental applications once one of said plurality of rental applications has been accepted by said one of said owners.

18. The system of claim 17, further comprising:
calculating an average balance from said ledger;
a renter score module configured to calculate a renter score based upon said plurality of periodic payments, said average balance, the ratio of said payment amount in relation to said average balance, and further based upon the frequency and punctuality of said payment amount in relation to said payment date; and
displaying said renter score to said owner once one of said plurality of rental applications is received, said renter score providing a risk assessment related to said renter who submitted one of said plurality of rental applications;
wherein said owner will utilize said renter score to assess the risk of a prospective renter.

19. The system of claim 16, wherein said ledger module further comprises:
extracting all transactions from said ledger;
removing all transactions below a minimum value, said minimum value comprising the average periodic payment amount for the same or similar entity in the same geographic region;
calculating the highest transaction value;
comparing the highest transaction value to a subsequent transaction;
adding said subsequent transaction to an originator payment chain if they are over said minimum value after a recurring period and within a delay range and within a fluctuation range, said recurring period comprising a defined time period for periodic payments, said delay range comprising a range before or after said recurring period, said fluctuation range comprising a percentage of said highest transaction value;
recursively adding subsequent transactions to said originator payment chain by comparing them to said highest transaction value, wherein said subsequent transactions are added if they occur after the recurring period and within the delay range and within the fluctuation range; and
wherein all of said transactions above said minimum value are analyzed and either grouped into originator payment chains or remain ungrouped.

20. The processor-implemented method of claim 19, further comprising calculating a renter score by multiplying the length of the originator payment chain by the difference between the value of the highest originator payment chain and the reward periodic payment amount, adding the average balance, and dividing this result by the reward periodic payment amount for the applied-for entity.
